(19) United States
(12) Patent Application Publication
(10) Pub. No.: US 2007/0263895 A1
(43) Pub. Date: Nov. 15, 2007

(54) Microphone and Method of Manufacturing Microphone

(75) Inventors: Tooru Himori, Kanagawa (JP); Futoshi Takeshi, Kanagawa (JP); Katsushige Yoshida, Kanagawa (JP)

Correspondence Address: MCDERMOTT WILL & EMERY LLP, 600 13TH STREET, NW, WASHINGTON, DC, 20005-3096, US

(73) Assignee: Panasonic Semiconductor Device Solutions Co., Ltd., Kanagawa (JP)

(21) Appl. No.: 11/662,926

(22) PCT Filed: Nov. 22, 2005
(86) PCT No.: PCT/JP05/21460

§ 371 Date: Mar. 15, 2007

(30) Foreign Application Priority Data
Dec. 8, 2004 (JP) 2004-355104

(51) Int. Cl. H04R 9/08

(52) U.S. Cl. 381/365; 381/361

(57) ABSTRACT

Regarding a microphone mounted on a small-sized device such as a mobile telephone terminal or the like, fine workability of an insertion hole for a coil spring, working accuracy of its insertion hole, and control property of the coil spring (self-sustaining property of the coil spring) are sufficiently secured, a problem of limitation in used materials is also eliminated, and assembly work is facilitated, whereby automation of assembly can be permitted. Through coil springs 20A, 20B connected to a microphone unit 10, the microphone unit 10 is housed in a first holder 30 made of hard material. Further, the first holder 30 which houses therein the microphone 10 through the coil springs 20A, 20B is housed in a second holder 40 made of elastic material. By this constitution, positional accuracy of the coil spring can be readily secured, the used materials can be also selected without being limited, and the assembly can be also facilitated.

### TECHNICAL FIELD

The present invention relates to a microphone and a method of manufacturing the microphone, and particularly to a microphone mounted on a device which requires size-reduction such as a mobile telephone.

### BACKGROUND ART

As an electret condenser microphone (ECM), there is a microphone including a microphone unit (which has, for example the shape of a short cylinder, and an electrode pattern for external connection at its bottom surface or upper surface), a holder for housing its microphone unit therein, and a pair of springs functioning as an external connection terminal of the microphone unit (of which each has one end brought into contact with each of a pair of electrode patterns of the above microphone unit, and the other end connected electrically to a voice processing analog front end of a mobile telephone or the like).

The microphone unit has a function (electroacoustic conversion function) of converting change in electrostatic capacitance of a condenser which changes according to an acoustic signal into an electric signal and outputting its electric signal.

Heretofore, as this type of microphone, there is, for example, a microphone described in Patent Document 1. The microphone described in the Patent Document 1 adopts the structure of holding a microphone unit by a rubber-made holder.

FIG. 7 shows a sectional view showing an example of the structure of the conventional microphone (the structure of the microphone described in the Patent Document 1).

As shown in FIG. 7, this microphone has the structure in which after coil springs 50A and 50B have been inserted into a usual rubber holder 60 made of elastic material, a microphone unit 70 is inserted into the rubber holder 60 and fixed thereto so as to be enveloped in the rubber holder 60.

Further, a microphone described in Patent Document 2 uses a holder which is integrally formed of soft material and hard material by dissimilar-material molding.

Namely, the holder which holds the microphone unit therein requires flexibility for facilitating housing of the microphone unit, and rigidity by which the. spring (contact spring) functioning as the external connection terminal can be held firmly, which are contrary to each other. Therefore, in the microphone described the Patent Document 2, an auxiliary plate made of hard material and a holder body made of soft material are integrally formed thereby to meet the flexibility and the rigidity.

FIG. 6 shows a sectional view showing an example of the structure of the conventional microphone (the structure of the microphone described in the Patent Document 2).

As shown in FIG. 6, this microphone has structure in which after coil springs 80A and 80B have been inserted into a holder formed integrally by insert-molding a hard auxiliary plate 95 made of hard material into a holder body 90 made of soft material, and a microphone unit 100 is inserted and fixed into the holder so as to be enveloped in the holder body. A reference numeral 81 is a seat portion of the coil spring, and a reference numeral 82 is a coil spring seat bottom portion.

Patent Document 1: JP-A-2002-262396 (FIGS. 2 and 7)

Patent Document 2: JP-A-2003-346959 (Page 4, FIG. 2)

### DISCLOSURE OF THE INVENTION

Size-reduction and weight-reduction of electronic devices such as a mobile telephone terminal and the like are proceeding, and with these size-reduction and weight reduction, the needs of size-reduction of a microphone mounted on such the device are increasing recently.

As the size of the microphone becomes smaller, the area of an electrode pattern with which the coil spring is brought into contact becomes also smaller. The coil spring functioning as an external connection terminal, since it must be exactly brought into contact with its fine electrode pattern, requires its positional accuracy more than the coil spring in the conventional microphone unit.

The inventor of the invention has investigated the above related art, on the assumption that the invention corresponds to such the circumstances. In result, the following points have become clear.

(1) Diameter of Hole for Coil Spring Insertion, and Working Accuracy of its Hole

In the microphone (FIG. 9) described in the Patent Document 1, the whole of the rubber holder is formed of rubber. Therefore, there is a limit to fining of diameter of a coil spring insertion hole and to working accuracy of its hole. The microphone described in the Patent Document 2 is the same as the microphone described in the Patent Document 1 in that an insertion hole for a coil spring must be provided in a holder made of elastic material, and the result of investigation similar to that in the microphone described in the Patent Document 1 is obtained.

(2) Control Property of Coil Spring (Self-Sustaining Property of Coil Spring)

Basically, the microphone is used within a natural use range of a product (in a working position). However, in the actual use, a case in which the microphone is used over the natural use range is also assumed. In the microphone using the coil spring, in case that the coil spring is pressed over the use range even for an instant, the coil spring is put in a closely wound state (that is, a state in which a winding wire becomes close and cannot exhibit the elastic force), and spring characteristic assumed in design cannot be obtained.

In both types of microphones (FIGS. 8 and 9) in the Patent Document 1 and the Patent Document 2, the holder made of the elastic material is concerned with the portion (opening portion) for regulating the coil spring. Therefore, there are possibilities of lowering in working accuracy of the holder, and deformation of the holder itself due to external pressure, and it cannot be stated that there is no fear that the coil spring will be put in the closely wound state.

Further, as the coil spring is compressed more, not only the deformation of the spring in the vertical direction but also a small tilt thereof arises, so that there is possibility that the coil spring moves wildly. In case that the coil spring acts wildly, variation in position of an end point (a contact point) of its coil spring is produced considerably, and it becomes difficult to assume its position.

In the structure where the holder made of the elastic material is concerned with the portion (opening portion) for regulating the coil spring, it cannot be stated that there is no fear that the coil spring will moves wildly.

Further, in order to suppress the tilt of the coil spring as much as possible, it is thought that the depth of the coil spring insertion hole made of the elastic material (soft material) is increased. However, in this case, control property of the coil is weak because the coil spring insertion hole is made of the soft material, and a desirable result is not always obtained. Rather, there is fear that load will be directly applied from the outside onto the holder because the protruding amount of the coil spring from the insertion hole is small.

(3) Problems Due to Dissimilar-Material Molding (Generation of Warp and Difficulty of Molding)

In the microphone described in the Patent Document 2 (FIG. 8), the holder integrally formed of the soft material and the hard material by dissimilar-material molding limits the usable materials. Further, since shrinkage rates of the respective materials are different, it cannot be stated that there is no possibility that warp or deformation is produced. In case that the warp is produced, there is possibility that the necessary accuracy cannot be obtained.

Further, the dissimilar-material molding requires special technology, and is disadvantage in productivity.

(4) Assembly Working Efficiency (Built-In Efficiency) of Microphone in Assembly and Possibility of Assembly Automation

Considering built-in efficiency of the microphone, usually, after the coil springs have been inserted into the holder, the microphone unit is inserted. After the microphone unit has been inserted, the end portion of the opening portion of the holder is constituted so as to envelop the microphone unit in the holder in order to prevent the microphone unit from coming out. The microphones described in the Patent Document 1 and the Patent Document 2 are also assembled by this method.

When the microphone unit is housed in the holder (when the microphone unit is inserted into the holder), it is necessary to expand the insertion opening of the holder. At this time, since the coil spring is released from any suppression (since the coil spring is not under a pressed state), the coil spring is easy to move wildly. In this point, the assembly is difficult. Therefore, the automation of assembly is also difficult.

The invention has been made in view of the above circumstances. An object of the invention is to provide a microphone mounted on a small-sized device such as a mobile telephone terminal or the like, which can secure sufficiently fine workability of an insertion hole for a coil spring, working accuracy of its insertion hole, and control property of coil spring (self-sustaining property of coil spring).

Further, another object is to remove a problem of difficulty in molding of the microphone by preventing warp thereof, and to permit automation of assembly by facilitating assembly work.

A microphone of the invention includes a first holder which is formed so that it can hold a microphone unit and a spring in a state where one end of the spring functioning as an external connection terminal comes into contact with the microphone unit, and a second holder which holds this first holder and the microphone unit so as to envelop them therein, and is formed of material which is softer than the material of the first holder.

The first holder made of hard insulating material and the second holder made of soft insulating material are separate completely, and these holders that are separate bodies and the microphone unit are combined, thereby to form one a microphone. Only the first holder made of the hard material is concerned with the coil spring, and the concernment of the second holder made of the soft material is completely eliminated, whereby fine workability of an insertion hole for the coil spring, high working accuracy of the insertion hole and good control property (good self-sustaining property) of the coil spring are secured. Here, “hard” and “soft” mean “relatively hard” and “relatively soft”, and the first holder is harder than the second holder.

Namely, in the first holder made of the hard material, since the insertion hole of a small diameter can be worked with good accuracy, positional accuracy of the coil spring can be secured, and contact stability can be secured even in case that the contact area of the microphone unit with the coil spring is small. Further, also regarding variation in the contact point due to a tilt of the coil spring in the compression time, since the first holder is made of the hard material, the range of its variation is readily assumed. Further, the depth of a through hole (and a wide hole portion for housing therein a coil spring seat portion) in the first holder made of the hard material is designed larger than the height of the coil spring under a closely wound state, whereby the closely wound state of the coil spring can be surely avoided, and good self-sustaining property of the coil spring can be secured. Accordingly, when the microphone is assembled in the mobile telephone terminal or the like, such the situation that the coil spring enters the closely wound state and characteristics of the coil spring are lost is not produced. This point contributes also to improvement of assembly working efficiency. Further, since the first holder made of the hard material and the second holder made of the soft material, which are separate bodies, are used in the invention, a problem such as the limitation of usable materials, fear of generation of warp, or difficulty of molding is not produced unlike the case of a dissimilar-material molding product. Further, in a state where the coil spring and the microphone unit are attached in the first holder, the coil spring is pressed on the microphone unit and the movement of the coil spring is regulated. Therefore, there is no anxiety that the coil spring moves wildly. Namely, in the first holder, a state where the coil spring and the microphone unit are stably fixed temporarily is realized. Under this state, the first holder is inserted into the second holder, whereby good assembly working efficiency is obtained. Further, when the coil spring and the microphone unit are attached into the first holder, they are only inserted continuously vertically, and directivity is not required. Therefore, also on this point, the assembly working efficiency is good. Further, it is also easy for the second holder to envelop the first holder and the microphone unit therein. Therefore, automation of assembly is also easy.

Further, in the microphone of the invention, a pair of electrode patterns is provided on an upper surface or a bottom surface of the microphone unit, the first holder has a hollow which can house therein the microphone unit partially, through holes for inserting a pair of the springs therein are provided in portions corresponding to a pair of the electrode patterns on the bottom surface of its hollow, and the second holder is constituted so as to cover the side surface of the first holder and the portion of the microphone unit which comes out from the first holder.

In the first holder, the through holes are provided in the exact positions corresponding to the electrode patterns on the microphone unit; the first holder is provided with the hollow for smoothly housing therein the microphone unit without hindrance thereby to house the microphone unit partially (,and the first holder has a fall-out preventing rib on a part of an inner wall thereof to fix the microphone unit temporarily); and the second holder is constituted so as to envelop the side surface and the end portion of the microphone unit and the side surface of the first holder. Since a part of the side surface of the microphone unit comes into contact with the second holder made of the soft material directly, the minute vibration of the microphone unit is relaxed, a gap from the upper surface of the microphone unit to the bottom surface thereof can be eliminated, and the microphone unit can be surely covered tightly, so that an effect of a sound leak prevention is obtained.

Further, in the microphone of the invention, the spring is a conical coil spring having a seat portion at its bottom, and a hole diameter at the end on the microphone side of the through hole provided in the first holder is wider than a hole diameter at the other portion. In its wider portion, the seat portion of the coil spring is housed.

The use of the conical coil spring having the seat portion can make the solid height short, and since the seat portion is firmly held between the first holder and the microphone unit, the coil spring can be stably fixed and can stand by itself vertically. Since the through hole in the first holder has the wide portion, the seat portion of the coil spring can be stably housed in its wide portion.

Further, in the microphone of the invention, the depth of the through hole provided in the first holder is larger than the height of the body portion of the spring in the closely wound state.

Hereby, even in case that the coil spring is pushed into the through hole, the situation in which the coil spring enters the closely wound state and characteristics of the coil spring are not exhibited is not produced. Further, such the wild movement that the coil tilts can be also surely prevented. Therefore, the good self-sustaining property of the coil spring can be secured. Accordingly, when the microphone is assembled in the mobile telephone terminal or the like, such the situation that the coil spring enters the closely wound state and the characteristics of the coil spring are lost is not produced. This point contributes also to improvement in assembly working efficiency.

Further, in the microphone of the invention, in the first holder, the depth of the wide portion in which the spring seat portion is housed is the same or more as or than the height of the spring seat portion in the closely wound state.

Hereby, it is possible to prevent the characteristics of the coil spring from not being exhibited due to the closely wound state of the coil spring seat portion.

Further, the microphone of the invention has a rib for preventing fall-out of the microphone unit on a part of a surface which contacts the microphone unit, of the side wall of the first holder.

By providing this fall-out preventing rib on the inner wall of the first holder, the inserted microphone unit is temporarily fixed. Therefore, in a state where the microphone unit is inserted into the first holder, the microphone unit can be carried and becomes easy to handle, and the microphone becomes easy in assembly. Further, this fall-out preventing rib has also an advantage that positioning accuracy of the microphone unit is improved.

Further, the microphone of the invention has, on a part of the bottom surface of the hollow in which the microphone unit can be partially housed, a curling relief portion for relieving a projection of a curling portion of the microphone unit.

Since the curling portion of the microphone unit is housed in the curling relief portion of the first holder, there is not any problem. In case that the microphone unit tilts due to its projection and flatness of the main surface of the microphone unit worsens, the stable contact at the contact point of the coil spring is not secured. However, since the curling relief portion is previously provided, such the situation is not produced.

Further, in the microphone of the invention, a pair of sound leak preventing ribs are provided on an inner surface and an outer surface of the side wall portion of the second holder contacting the side surface of the microphone unit.

Since the first holder is made of hard material and the microphone unit (a casing of the microphone unit) is formed also of hard material, the hard materials come into contact with each other at the contact portion of the first holder and the microphone unit, so that the effect of absorbing the fine vibration of the microphone unit is small. Accordingly, as described above, the side wall of the second holder made of the soft material is directly brought into contact with the side surface of the microphone unit, whereby the vibration can be absorbed by the second holder. However, in case that the contact between the second holder and the microphone unit is weak, there is a case where the vibration absorbing effect is not obtained sufficiently. Therefore, a pair of ribs (for example, lump-shaped projections) are provided on the inner surface and the outer surface of the side wall of the second holder contacting the side surface of the microphone unit, whereby the side wall of the second holder is attached closely to the side wall of the microphone unit firmly. The rib on the inner surface performs an operation of pressing the side wall of the microphone unit strongly. When the first holder in which the microphone unit is inserted is inserted into the second holder, since the internal diameter of the inner rib is made smaller than the external diameter of the microphone unit 10, the second holder bulges out correspondingly to the inner rib. In insertion of the microphone of the invention, the outer rib, by being regulated by, for example, a housing in which the microphone is inserted, attaches the inner rib closely onto the side surface of the microphone unit, thereby to have sound leak preventing effect more. Further, by making the close attachment between the housing into which the microphone is inserted and the microphone of the invention good, there is also the sound leak preventing effect at its close attachment portion (refer to FIG. 7). Hereby, the second holder made of the soft material attaches closely to the microphone unit firmly without a clearance, so that the vibration of the microphone unit is effectively absorbed by the second holder, and the sound leak preventing effect is increased.

Further, in the microphone of the invention, the first holder is formed of hard rubber.

Further, in the microphone of the invention, the first holder is formed of hard synthetic resin.

Further, in the microphone of the invention, the first holder is formed of any one of liquid crystal polymer, polyacetal, and polybuthylene terephthalate.

Further, in the microphone of the invention, the second holder is formed of soft rubber insulating material.

Further, in the microphone of the invention, the second holder is formed of either of silicon or elastomer.

Further, a microphone manufacturing method of the invention includes a first step of inserting the spring into a through hole of the first holder, a second step of inserting the microphone unit into the hollow of the first holder into which the spring is inserted, and a third step of fixing the first holder and the microphone unit in the second holder.

The first and second holders that are separate bodies are used. Firstly, in the first holder, the coil spring and the microphone unit are housed in order (in this state, the movement of the coil spring is regulated in the first holder, and the microphone unit is temporarily fixed), and the first holder and the microphone unit are fixed by the second holder so as to be enveloped in the second holder. Since the coil spring and the microphone unit are only inserted into the first holder vertically and continuously, directivity is not required, so that working efficiency is good. Further, the first holder in the state where it houses the microphone unit therein can be also solely handled, the spring stands by itself vertically, and there is no anxiety of the wild movement of the spring. Therefore, it is easy for the second holder to envelop the first holder and the microphone unit therein. Accordingly, assembly automation of the microphone is also possible.

An electroacoustic converter of the invention is an electroacoustic converter on which the microphone of the invention is mounted.

There is obtained the electroacoustic converter which has small size and little sound leak, and is strong also in mechanical stress in actual use.

Further, a portable communication terminal unit of the invention is a portable communication terminal unit on which the microphone of the invention is mounted.

The microphone of the invention has small size and little sound leak, is strong also in mechanical stress in actual use, and is easy to be built in the portable communication terminal unit. Therefore, improvement of performance of the portable communication terminal unit, and reduction of assembly cost thereof are realized.

In the invention, the first holder made of the hard material and the second holder made of the soft material are separate completely, and these separate holders and the microphone unit are combined, thereby to form one microphone. Only the first holder made of the hard material is concerned with the coil spring, and the concernment of the second holder made of the soft material is completely eliminated, whereby it is possible to secure fine workability of the insertion hole for the coil spring, high working accuracy and good control property (good self-sustaining property) of the coil spring.

Further, since the holders which are the separate bodies are used, the problems such as the limitation of usable materials and the generation of warp are not produced unlike the case of the dissimilar-material molding product, and there is no hindrance on production.

Further, since the coil spring and the microphone unit are only inserted in the first holder continuously vertically, the directivity is not required, and the working efficiency is good. Further, the first holder in the state where it houses the microphone unit therein can be also solely handled, the spring stands by itself vertically, and there is no anxiety of the wild movement of the spring. Therefore, it is easy for the second holder to envelop the first holder and the microphone unit therein. Accordingly, the assembly automation of the microphone is also possible.

Therefore, regarding the microphone mounted on the small-sized device such as the mobile telephone terminal or the like, the fine workability of the insertion hole for the coil spring, the working accuracy of its insertion hole, and the control property of the coil spring (self-sustaining property of coil spring) are sufficiently secured, the problems such as the warp and the difficulty of molding are also eliminated, and the assembly work is facilitated, whereby the assembly automation can be realized. Accordingly, a novel and useful microphone can be provided.

Specifically, according to the microphone of the invention, since the insertion hole of the small diameter can be worked with good accuracy, the positional accuracy of the coil spring can be secured, and the contact stability can be secured even in case that the contact area of the microphone unit with the coil spring is small.

Further, the self-sustaining property of the coil spring is also good, and the depth of the penetrating portion and the spring seat portion of the first holder is set larger than the height of the coil spring under the closely wound state, whereby the closely wound state of the coil spring can be avoided. Accordingly, the situation in which the coil spring enters the closely wound state in assembly of the microphone in the mobile telephone or the like and characteristics of the coil spring are lost can be prevented, and the assembly automation is also possible.

Further, in the first holder, the relief portion for housing the curling portion of the microphone unit is provided, whereby the contact point of the coil spring can be surely stabilized and the coil spring can be brought into contact with the microphone unit.

Further, in the microphone unit inserted portion, the microphone unit fall-out preventing ribs are equally provided, whereby the positional accuracy of the microphone unit is secured, the microphone unit can be carried in the inserted state into the first holder, and handling such as assembly efficiency can be improved.

Further, since fitting portions between the first holder and the microphone unit are made of the hard material respectively, the sound leak from the contact point side cannot be surely prevented. In consideration of this point, by directly bringing the second holder made of the soft material into contact with a part of the side surface of the microphone unit, and further providing the sound leak preventing rib to increase the close attachment between the second holder and the microphone unit, the sound leak can be prevented.

Further, as the coil spring, the conical coil spring is used in order to make the solid height short and be firmly pressed between the first holder and the microphone unit at its seat portion.

Further, the assembly procedure of inserting the coil spring in the first holder and thereafter forcing the microphone unit into the first holder is the work of inserting each member in the vertical direction, and the directivity is not required. Therefore, the assembly automation is possible. Further, under its state, the coil spring is surely fixed without moving wildly. Therefore, it is easy to envelop the unit in which the coil spring and the microphone unit are attached in this first holder in the second holder.

Further, since the structure in which the unit in which the coil spring and the microphone unit are attached in the first holder is enveloped in the second holder is adopted, the assembly automation of the microphone of the invention is also possible.

Further, since both the first holder and the second holder can select the material freely, the material can be selected according to the needs, so that production efficiency can be increased.

In case that the area of the electrode pattern is reduced with the miniaturization of the microphone unit, if the positional accuracy of the coil spring brought into contact with the electrode pattern is bad, the poor contact is produced. However, in the microphone of the invention, since the positional accuracy of the coil spring can be kept high, there is no anxiety of the poor contact. Therefore, it is possible to obtain a microphone which can be thoroughly mounted also on the mobile telephone terminal in which miniaturization is advancing, and which has good performances.

### BRIEF DESCRIPTION OF THE DRAWINGS

FIG. 1 is a sectional view showing one example of structure of a microphone of the invention.

FIG. 2 is a perspective view showing one example of structure of the microphone of the invention.

FIG. 3 is a diagram showing concrete structure of a first holder, in which FIG. 3(a) is a sectional view of the first holder, and FIG. 3(b) is a plan view of the first holder (including partially an enlarged view).

FIG. 4 is a side view showing the shape of a coil spring.

FIG. 5 is a sectional view showing one example of structure of a second holder.

FIG. 6 is a diagram for explaining an assembly procedure of the microphone of the invention, showing an exploded sectional view of each part.

FIG. 7 is a mounting diagram of the microphone of the invention.

FIG. 8 is a sectional view showing one example of structure of a conventional microphone (structure described in Patent Document 2).

FIG. 9 is a sectional view showing one example of structure of a conventional microphone (structure described in Patent Document 1).

10, 70, 100 Microphone unit

11a, 11b Electrode pattern (Contact pattern)

12 Curling portion

20A, 20B, 50A, 50B, 80A, 80B Coil spring

30 First holder

40 Second holder

60 Rubber holder

21, 51, 81 Coil spring seat portion

22, 52, 82 Coil spring seat bottom portion

31 Depth of through hole for coil spring

32A, 32B Spring insertion hole

33A, 33B Coil spring fitting portion

34 Curling relief portion of microphone unit

35 Microphone unit inserting portion

36A, 36B, 36C Fall-out preventing rib for microphone unit

41, 42, 43, 44 Sound leak preventing rib

90 Rubber holder (soft material)

95 Rubber holder (hard material)

110 Housing

120 Print board

### BEST MODE FOR CARRYING OUT THE INVENTION

Embodiments of the invention will be described below with reference to drawings.

### First Embodiment

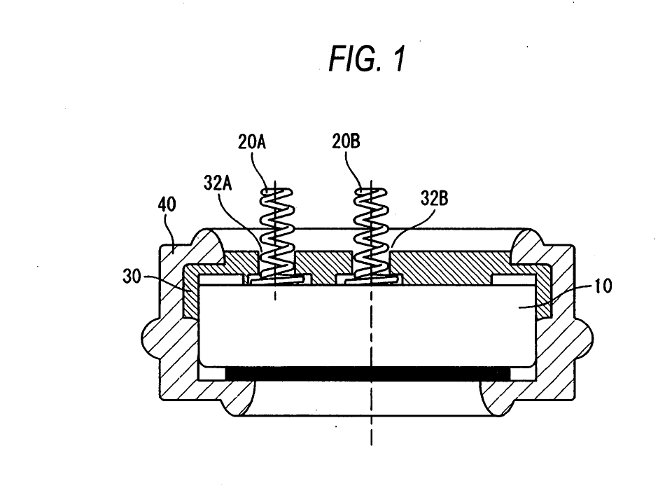

FIG. 1 is a sectional view showing one example of structure of a microphone of the invention.

As shown in FIG. 1, the microphone of the invention includes a microphone unit 10, a pair of coil springs (contact springs) 20A, 20B, a first holder 30 made of hard material, and a second holder 40 made of soft material.

As hard insulating materials that are usable for the first holder 30, there are hard rubber and hard synthetic resin. Specifically, polyacetal, polybuthylene, liquid crystal polymer, and the like can be used.

Further, as soft insulating material that is usable for the second holder 40, there is soft rubber material such as silicon or elastomer.

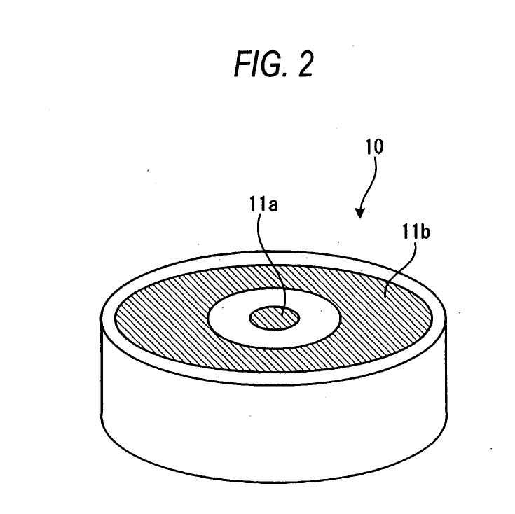

The microphone unit 10, as shown in FIG. 2, is formed in the shape of a short cylinder, and has on its upper surface (bottom surface) a pair of electrode patterns (i.e., a land 11a in the center and a concentric land 11b).

In positions of the first holder 30 corresponding to the electrode patterns (11a, 11b) on the upper surface of the microphone unit 10, coil spring insertion holes 32A, 32B for inserting a pair of coil springs 20A, 20B therein are provided.

Into the coil spring insertion holes 32A, 32B, the coil springs 20A, 20B are inserted, the microphone unit 10 is forced in a hollow formed inside the first holder 30 (namely, the microphone unit 10 is inserted into the hollow upon reception of pressure), and the first holder 30 in which the microphone unit 10 is temporarily fixed is housed in the second holder 40 (namely, the microphone unit 10 and the first holder 30 are fixed so as to be enveloped by the second holder 40).

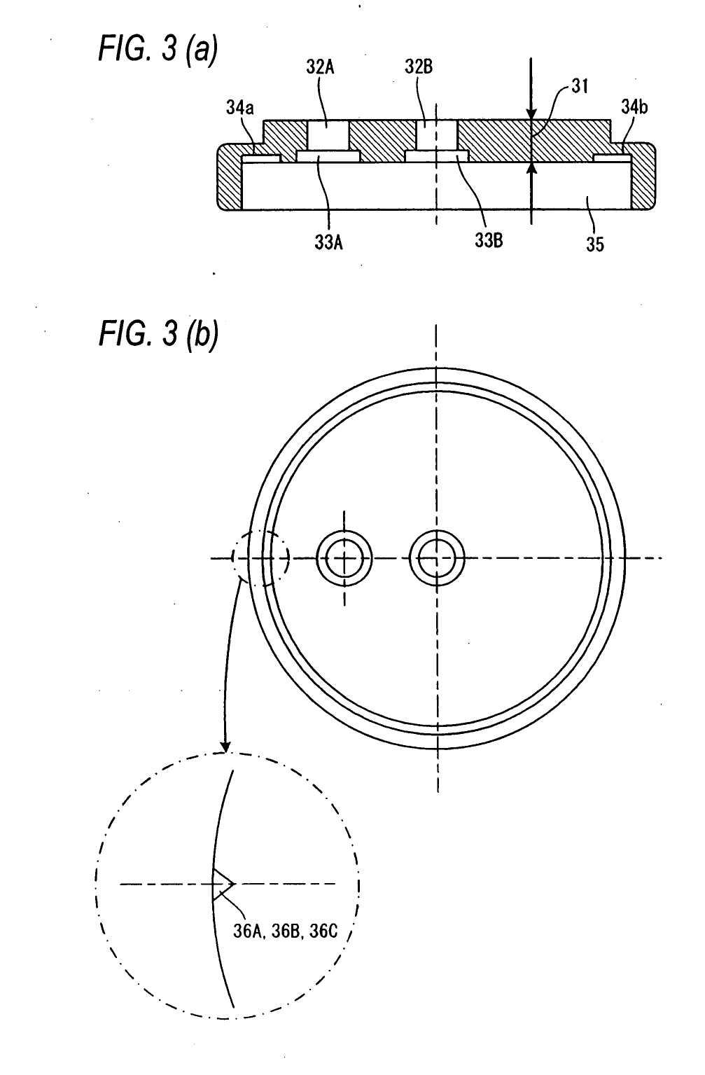

FIG. 3 is a diagram showing concrete structure of the first holder, in which FIG. 3(a) is a sectional view of the first holder, and FIG. 3(b) is a plan view of the first holder (including partially an enlarged view).

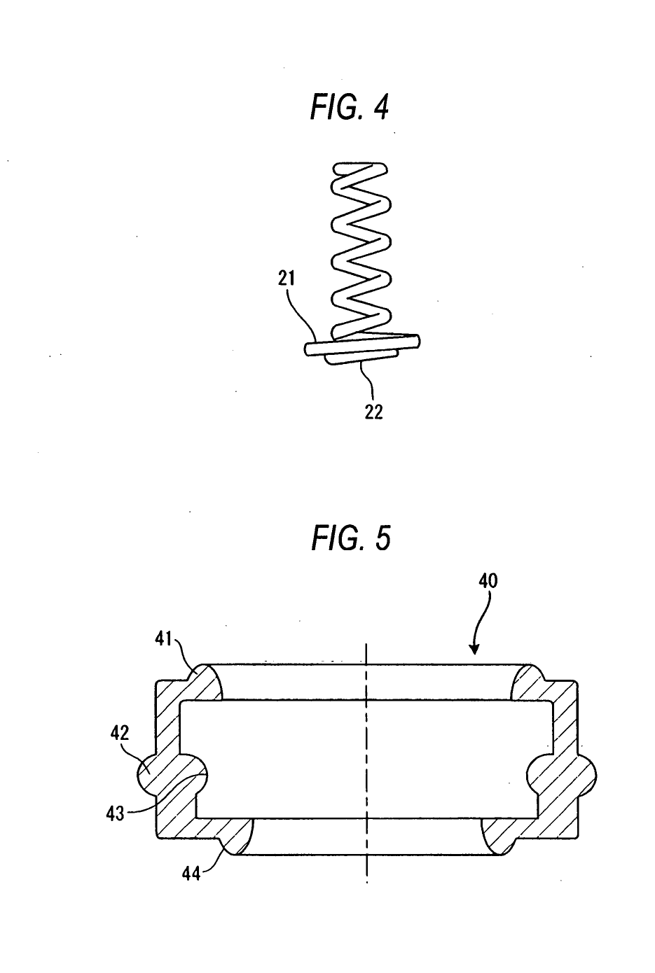

As shown in FIG. 3 (a), the coil spring inserting portions 32A, 32B of the first holder 30 communicate with wide holes 33A, 33B for housing and fixing seat portions (reference numeral 21 in FIG. 4) which are bottom portions of the coil springs 20A, 20B, thereby to form through holes (by 32A and 33A, and by 32B and 33B). A gentle taper is provided for the through hole.

The depth 31 of the through hole for housing therein the coil spring 20A, 20B is designed larger than the height of the coil spring 20A, 20B under a closely wound state, whereby even in case that the coil spring 20A, 20B are pressed strongly, it does not enter the closely wound state, and it never moves wildly.

Further, similarly, the depth of the wide hole 33A, 33B for housing and fixing therein the seat portion (reference numeral 21 in FIG. 4) that is the bottom portion of the coil spring 20A, 20B is also designed larger than the height at the seat portion of the coil spring 20A, 20B under the closely wound state, whereby generation of the closely wound state of the spring is prevented.

Further, as shown in FIG. 3(b), in the hollow 35 for housing therein the microphone unit 10, microphone unit fall-out preventing ribs 36A, 36B and 36C are equally provided.

By this rib 36A, 36B, 36C, tolerance of the microphone unit 10 and tolerance of the microphone unit insertion hole 35 provided in the first holder 30 are absorbed, and the microphone unit 10 can be surely forced in the first holder 30. Further, since fall-out of the microphone unit 10 is prevented, the first holder 30 in the state where the microphone unit is inserted therein can be also handled. This point contributes to improvement of efficiency of assembly working.

Further, the first holder 30 has curling relief portions 34a, 34b of the microphone unit. Hereby, a projection generated in curling (caulking) of the microphone unit 10 can be absorbed. Accordingly, the microphone unit 10 can keep its surface flatness without tilting, and vertical self-sustaining property of the coil spring 20A, 20B can be secured.

As described before, as the hard insulating materials that are usable for this first holder 30, polyacetal, polybuthylene, liquid crystal polymer, and the like can be used. Here, the liquid crystal polymer points to thermoplastics resin which enters a liquid crystal state usually in the melting time. In a wide sense, the liquid crystal polymer includes also aramid which enters a liquid crystal state when aramid dissolves in a solvent. The former is referred to as a thermotropic LCP, and the latter is referred to as a lyotropic LCP. The LCP commercialized as structure material is almost aromatic polyester, but there is also a type including ether bonding or imide bonding. The feature of the LCP is that: the usual liquid crystal polymer intertwines in the shape of a thread in the melting time, while having regularity, and the usual liquid crystal polymer has the basically same structure in the hardening time. Therefore, a molding product which has no molding change such as shrinkage and has regular molecular structure is obtained. In result, material properties such as high strength, high rigidity, low shrinkage rate, and high fluidity are obtained. It is also a great characteristic that anisotropy exits in the material properties from the above melting behavior.

FIG. 4 is a side view showing the shape of the coil spring.

As shown in FIG. 4, the coil spring (20A, 20B) is a conical coil spring having a seat portion 21. A mall winding exists in a coil spring bottom portion 22 so that a coil spring top portion does not get caught in the seat portion.

This coil spring seat portion 21 is rammed into the wide hole (seat portion fixing hole) 33A, 33B communicating with the coil insertion hole 20A, 20B of the first holder 30, and next the microphone unit 10 is inserted into the first holder and pressurized thereby to interpose the seat portion 21 of the coil spring (20A, 20B) between the microphone unit 10 and the first holder 30.

By interposing the coil spring seat portion 21, the coil spring is fixed and sustained by itself vertically.

FIG. 5 is a sectional view showing one example of structure of the second holder.

The second holder is made of elastic material, and provided with sound leak preventing ribs 41, 42, 43 and 44.

Particularly, the sound leak preventing ribs 42 and 43 are important. These ribs 42 and 43 are provided on an inner surface and an outer surface that are opposed to each other, of a side wall of the second holder 40 near the end of the first holder 30.

Since the first holder is made of hard material and the microphone unit (a casing of the microphone unit) is also formed of hard material, the hard materials come into contact with each other at the contact portion of the first holder and the microphone unit, so that the effect of absorbing the fine vibration of the microphone unit is small. Accordingly, as shown in FIG. 1, the side wall of the second holder 40 made of the soft material is directly brought into contact with the side surface (a part of the side surface) of the microphone unit 10, whereby the vibration can be absorbed by the second holder 40. However, in case that the contact between the second holder and the microphone unit is weak, there is a case where the vibration absorbing effect is not obtained sufficiently.

Therefore, a pair of ribs (lump-shaped projections) 43, 42 are provided on the inner surface and the outer surface of the side wall of the second holder 40 contacting the side surface of the microphone unit 10, whereby the side wall of the second holder 40 is attached closely to the side wall of the microphone unit 10 firmly.

The rib 43 on the inner surface performs an operation of pressing the side wall of the microphone unit 10 strongly, whereby the second holder 40 made of the soft material attaches closely to the microphone unit without a clearance, the vibration of the microphone unit is absorbed effectively, and the sound leak preventing effect is increased.

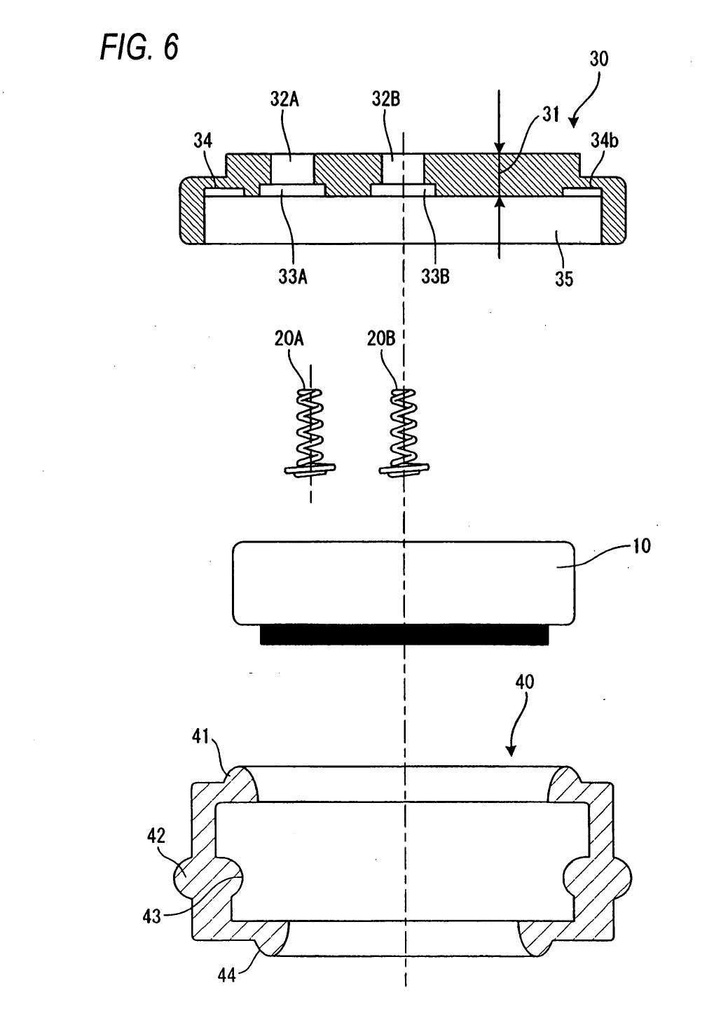

FIG. 6 is a diagram for explaining an assembly procedure of the microphone of the invention, showing an exploded sectional view of each part.

As shown in FIG. 6, firstly, the coil springs 20A, 20B are inserted into the first holder 30, and thereafter the microphone unit 10 is forced in the hollow 35 of the first holder 30.

The assembly procedure to these steps is the work of inserting each member vertically. Therefore, working efficiency is good. Further, since the directivity is not required, assembly automation of the microphone is possible. Further, in a state where the microphone unit 10 is housed in the first holder 10, the microphone unit 10 is temporarily fixed, and the coil springs 20A, 20B are surely fixed.

The depth 31 of the through hole in the first holder 30 for housing therein the coil spring 20A, 20B is designed larger than the height of the coil spring 20A, 20B under the closely wound state, whereby even in case that the coil spring 20A, 20B is pressed strongly, it does not enter the closely wound state, and it never moves wildly.

Lastly, the first holder 30 in this state and the microphone unit 10 are inserted into the second holder 40. The second holder 40, so as to envelope the side surfaces of the first holder 30 and the microphone unit 10, fixes them.

Since the second holder 40 is made of the soft material, the insertion opening is easy to expand. Further, since the coil spring 20A, 20B does not move wildly, this insertion work is also easy.

Further, a pair of sound leak preventing ribs may be provided on the inner surface and the outer surface of the side wall of the second holder contacting the side surface of the microphone unit.

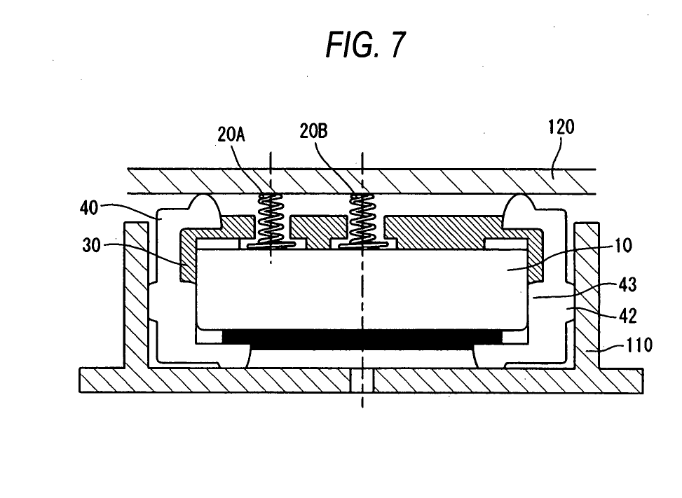

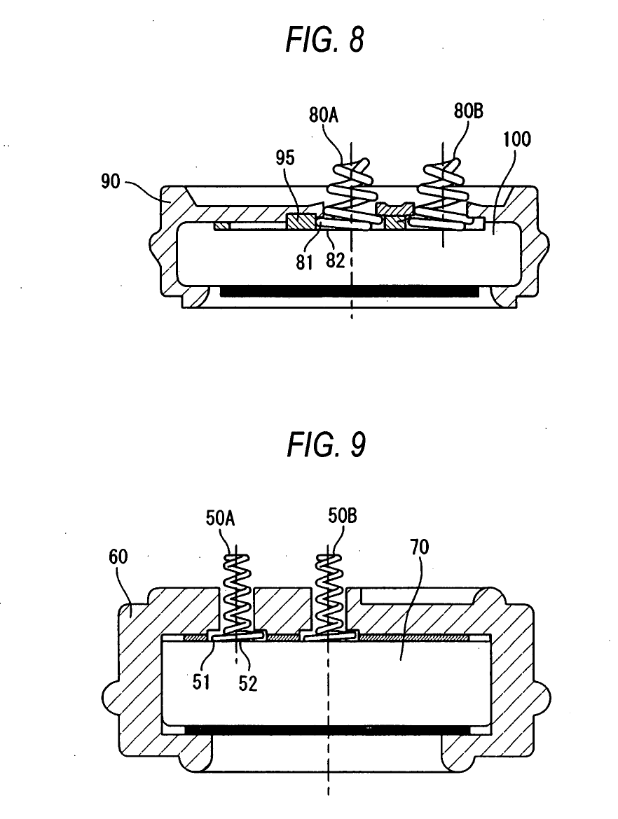

A pair of ribs (for example, lump-shaped projections) are provided on the inner surface and the outer surface of the side wall of the second holder contacting the side surface of the microphone unit, whereby the side wall of the second holder attaches closely to the side wall of the microphone unit firmly. The rib on the inner surface performs an operation of pressing the side wall of the microphone unit strongly. As shown in a mounting diagram of FIG. 7, when the first holder in which the microphone unit 10 is inserted is inserted into the second holder, since the internal diameter of the inner rib 43 is made smaller than the external diameter of the microphone unit 10, the second holder bulges out correspondingly to the inner rib 43. As clear from FIG. 7, in the inserting time of the microphone of the invention, the outer rib 42, by being regulated by, for example, a housing 110 in which the microphone is inserted, attaches the inner rib 43 closely onto the side surface of the microphone unit 10, thereby to have a sound leak preventing effect. Further, by making the close attachment between the housing into which the microphone is inserted and the microphone of the invention good, there is also the sound leak preventing effect at its close attachment portion. Hereby, the second holder made of the soft material attaches closely to the microphone unit firmly without a clearance, so that the vibration of the microphone unit is effectively absorbed by the second holder, and the sound leak preventing effect can be increased.

Thus, the microphone of the invention is good in assembly working efficiency, and makes the assembly automation possible.

As described above, in the invention, the first holder made of the hard material and the second holder made of the soft material are separate completely, these holders that are separate bodies and the microphone unit are combined thereby to constitute one microphone. Only the first holder made of the hard material is concerned with the coil spring, and the concernment of the second holder made of the soft material is completely eliminated, whereby fine workability of the insertion hole for the coil spring, high working accuracy thereof and good control property (good self-sustaining property) of the coil spring can be secured.

Further, since the separate holder bodies are used, there are no problems such as the limitation of usable materials and generation of warp, unlike the case of a dissimilar-material molding product, and there is also no hindrance on production.

Further, since the coil spring and the microphone unit are only inserted into the first holder vertically continuously, and the directivity is not required, the working efficiency is good. Further, since the first holder in which the microphone unit is housed can be solely handled, the spring stands vertically by itself, and there is no anxiety of the wild movement of the spring, it is easy for the second holder to envelop the first holder and the microphone unit therein. Therefore, the assembly automation of the microphone is also possible.

Therefore, regarding the microphone mounted on the small-sized device such as the mobile telephone terminal or the like, the fine workability of the insertion hole for the coil spring, the working accuracy of its insertion hole, and the control property of the coil spring (the self-sustaining property of the coil spring) are sufficiently secured, the problems such as the warp and the difficulty of molding are also eliminated, and the assembly work is facilitated, whereby the assembly automation can be realized. Accordingly, a novel and useful microphone can be provided.

Specifically, according to the microphone of the invention, since the insertion hole of the small diameter can be worked with good accuracy, the positional accuracy of the coil spring can be secured, and the contact stability can be secured even in case that the contact area of the microphone unit with the coil spring is small.

Further, the self-sustaining property of the coil spring is also good, and the depth of the penetrating portion of the first holder and the spring seat portion is set larger than the height of the coil spring under the closely wound state, whereby the closely wound state of the coil spring can be avoided. Accordingly, the situation in which the coil spring enters the closely wound state in assembly of the microphone in the mobile telephone or the like and characteristics of the coil spring are lost can be prevented, and the assembly automation is also possible.

Further, in the first holder, the relief portion for housing the curling portion of the microphone unit is provided, whereby the contact point of the coil spring can be surely stabilized and the coil spring can be brought into contact with the microphone unit.

Further, in the microphone unit inserting portion of the first holder, the microphone unit fall-out preventing ribs are equally provided, whereby positional accuracy of the microphone unit is secured, the microphone unit can be carried in the inserted state into the first holder, and handling such as assembly efficiency can be improved.

Further, since fitting portions between the first holder and the microphone unit are made of the hard material respectively, the sound leak from the contact point side cannot be surely prevented. In consideration of this point, by directly bringing the second holder made of the soft material into contact with a part of the side surface of the microphone unit, and further providing the sound leak preventing rib, the close attachment between the second holder and the microphone unit is increased, so that the sound leak can be prevented.

Further, as the coil spring, the conical coil spring is used in order to make the solid length short and be pressed between the first holder and the microphone unit firmly at its seat portion.

Further, the assembly procedure of inserting the coil spring in the first holder and thereafter forcing themicrophone unit into the first holder is the work of inserting each member in the vertical direction, and the directivity is not required. Therefore, the assembly automation is possible. Further, under its state, the coil spring is surely fixed without moving wildly. Therefore, it is easy to envelop the unit in which the coil spring and the microphone unit are attached in this first holder in the second holder. Accordingly, the assembly automation of the microphone of the invention is also possible.

Further, since both the first holder and the second holder can select the material freely, the material can be selected according to the needs, so that production efficiency can be increased.

In case that the area of the electrode pattern is reduced with the miniaturization of the microphone unit, if the positional accuracy of the coil spring brought into contact with the electrode pattern is bad, the poor contact is produced. However, in the microphone of the invention, since the positional accuracy of the coil spring can be kept high, there is no anxiety of the poor contact. Therefore, it is possible to obtain a microphone which can be thoroughly mounted also on the mobile telephone terminal or PDA (Personal Digital Assistance) in which miniaturization is advancing, and has good performances. The invention can be widely used in an electret condenser microphone, and can be also applied to other kinds of microphones.

### INDUSTRIAL APPLICABILITY

The invention has an advantage that the positional accuracy of the coil spring is high and a microphone that is good in assembly working efficiency can be provided. Therefore, the microphone of the invention is useful as a small-sized microphone which is mounted on the mobile telephone terminal or the PDA in which miniaturization is advancing.

1. A microphone comprising:
a microphone unit;
a first holder which is formed so that it can hold the microphone unit and a spring in a state where one end of the spring functioning as an external connection terminal comes into contact with the microphone unit; and
a second holder which holds this first holder and the microphone unit so as to envelop them therein, and is formed of material which is softer than the material of the first holder.

2. The microphone according to claim 1, wherein
a pair of electrode patterns is provided on an upper surface or a bottom surface of the microphone unit;
the first holder has a hollow which can house therein the microphone unit partially;
through holes for inserting a pair of the springs therein are provided in portions corresponding to a pair of the electrode patterns on the bottom surface of its hollow; and
the second holder is constituted so as to cover the side surface of the first holder and the side surface of the microphone unit portion which exposes from the first holder.

3. The microphone according to claim 2, wherein the spring is a conical coil spring having a seat portion at its bottom; and
a hole diameter at the end on the microphone side of the through hole provided in the first holder is wider than a hole diameter at the other portion, and in its wide portion, the seat portion of the coil spring is housed.

4. The microphone according to claim 2, wherein the depth of the through hole provided in the first holder is larger than the height of a body portion of the spring in the closely wound state.

5. The microphone according to claim 2, wherein in the first holder, the depth of the wide portion in which the spring seat portion is housed is the same or more as or than the height of the spring seat portion in the closely wound state.

6. The microphone according to claim 2, wherein on a part of a surface which contacts the microphone unit, of the side wall of the first holder, a rib for preventing fall-out of the microphone unit is provided.

7. The microphone according to claim 2, wherein on a part of the bottom surface of the hollow in which the microphone unit can be partially housed, a curling relief portion for relieving a projection of a curling portion of the microphone unit which is produced when the microphone unit is pressed on the above bottom surface and inserted into the hollow.

8. The microphone according to claim 2, wherein a pair of sound leak preventing ribs are provided on an inner surface and an outer surface of the side wall portion of the second holder which contacts the side surface of the microphone unit.

9. The microphone according to claim 1, wherein the first holder is formed of hard rubber.

10. The microphone according to claim 1, wherein the first holder is formed of hard synthetic resin.

11. The microphone according to claim 10, wherein the first holder is formed of any one of liquid crystal polymer, polyacetal, and polybuthylene terephthalate.

12. The microphone according to claim 1, wherein the second holder is formed of soft rubber insulating material.

13. The microphone according to claim 12, wherein the second holder is formed of silicon or elastomer.

14. A method of manufacturing the microphone according to claim 2, comprising:
a first step of inserting the spring into the through hole of the first holder;
a second step of inserting the microphone unit into the hollow of the first holder into which the spring is inserted; and
a third step of fixing the first holder and the microphone unit in the second holder.

15. An electroacoustic converter mounting thereon the microphone according to claim 1.

16. A portable communication terminal it mounting thereon the microphone according to claim 1.
